(19) United States
(12) Patent Application Publication
(10) Pub. No.: US 2016/0016553 A1
(43) Pub. Date: Jan. 21, 2016

(54) CONNECTING DEVICE BETWEEN A WIPER ARM AND A WIPER BLADE

(71) Applicant: Valeo Systèmes d'Essuyage, Le Mesnil Saint Denis (FR)

(72) Inventor: Michael Schaeuble, Vaihingen/Enz (DE)

(73) Assignee: Valeo Systèmes d'Essuyage, Le Mesnil Saint Denis (FR)

(21) Appl. No.: 14/791,671

(22) Filed: Jul. 6, 2015

(30) Foreign Application Priority Data
Jul. 17, 2014 (DE) 10 2014 110 063.8

(51) Int. Cl. B60S 1/40; B60S 1/38

(52) U.S. Cl. CPC B60S 1/4038; B60S 1/3806; B60S 1/4048; B60S 2001/4051; B60S 2001/4054

(57) ABSTRACT

A connecting device between a wiper arm and a wiper blade is disclosed. The wiper blade has an elongated wiper blade body with an adapter element which serves for exchangeable connecting to a connection region of the wiper arm, where the connection region of the wiper arm has a substantially U-shaped mount for the adapter element with an upper boundary surface and two lateral boundary surfaces. The mount overlaps the adapter element at least in the region of the boundary surfaces, and a first spoiler element is constructed in the connection region of the wiper arm for increasing the aerodynamic contact pressure of the wiper arm onto the wiper blade.

### PRIOR ART

The invention relates to a connecting device between a wiper arm and a wiper blade according to the precharacterizing clause of the two independent claims.

A connecting device according to the precharacterizing clause of the two independent claims is known from FR 2 886 254 A1. In the known connecting device, a spoiler- or lip-like element is arranged in the connection region between a wiper arm and a wiper blade on the upper side of the connection region of the wiper arm, said spoiler- or lip-like element serving to increase the contact pressure of the wiper arm, and therefore also of the wiper blade connected to the wiper arm, depending on the driving speed. Although the spoiler element known from the document mentioned has a high aerodynamic effect, depending on the specific configuration or shaping, the height of the wiper device is, however, increased in the connection region of the wiper arm, which may be of disadvantage depending on the installed position of the wiper arm on the motor vehicle. Furthermore, it is likewise known from the document mentioned to use, in the region of the wiper blade, spoiler-like caps which are arranged on the upper side of the wiper blade. However, just using spoiler-like caps of this type in the region of the wiper blade does not bring about any increase in the contact force in the connection region between the wiper arm and the wiper blade. The contact force which is reduced in comparison to the regions with the spoiler-like caps on the wiper blade can be increased by the spoiler element arranged in the region of the wiper arm in the connection region between the wiper blade and the wiper arm such that it is possible to obtain an at least substantially equally sized, speed-dependent contact force of the wiper blade against the vehicle window over the entire length of the wiper blade.

### SUMMARY OF THE INVENTION

Starting from the depicted prior art, the invention is based on the object of developing a connecting device between a wiper arm and a wiper blade according to the precharacterizing clause of the two independent claims in such a manner that in particular the overall height of the wiper arm is not increased in the connection region to the wiper blade. This object is achieved according to the invention in a connecting device between a wiper arm and a wiper blade with the features of the two independent claims.

In a first structural realization of the inventive concept, it is provided that the first spoiler element (in the connection region between the wiper arm and the wiper blade) is constructed as part of a lateral boundary surface of the mount of the wiper arm by a flat partial region of the lateral boundary surface of the mount positioned obliquely with respect to an onflow direction of the airstream, and that the angle of the partial region serving as first spoiler element is between 30° and 60°, preferably approximately 45°, in relation to a plane running parallel to the upper boundary surface of the mount. In other words, this means that a partial region of the connection region between the wiper arm and the wiper blade is constructed as a spoiler element in the region of the mount, and therefore the overall height of the mount and of the wiper arm is not increased in the connection region.

In an alternative structural configuration of the inventive concept, it is provided that the first spoiler element is constructed as part of a lateral boundary surface of the mount of the wiper arm by a flat partial region of the lateral boundary surface positioned obliquely with respect to an onflow direction of the air stream, and that the obliquely positioned partial region of the lateral boundary surface is arranged on the side facing the upper boundary surface, wherein the height of the partial region in relation to the height of the mount is between 20% and 80%, preferably approximately 50% of the height of the mount. In other words, this structural realization of the invention includes a large range of conceivable angles of a surface which is positioned obliquely with respect to the airstream and acts as a wind-deflecting surface, wherein it is essential merely that a certain height of the partial region or of the aerodynamically effective surface is available in order to obtain the required contact pressure.

Advantageous developments of the two connecting devices according to the invention between a wiper arm and a wiper blade are stated in the dependent claims. All combinations of at least two of the features disclosed in the claims, the description and/or in the figures fall within the scope of the invention.

In a particularly preferred structural development of the second alternative configuration of the invention, the angle of the partial region serving as first spoiler element is between 30° and 60°, preferably approximately 45°, in relation to a plane running parallel to the upper boundary surface.

In order, firstly, to make it possible for an operator to exchange the wiper blade on the wiper arm as simply as possible and in order, secondly, to optimize the aerodynamic effect of the first spoiler element as far as possible, it is proposed that on the adapter element at least a first detent element is constructed, which forms a detent connection together with a second detent element on the wiper arm, and that the partial region which forms a spoiler element extends up to the area of the second detent element with respect to a longitudinal direction of the mount.

In order to optimize the contact force in the region of the wiper blade, it is furthermore of advantage if the wiper blade body has on its upper side a second spoiler element, which runs at least substantially over the entire length of the wiper blade body, wherein in the region of the adapter element the second spoiler element is constructed so as to be interrupted or is overlapped by the adapter element.

In order to optimize the mechanical connection between the wiper blade and the wiper arm in the connection region, it is provided that the adapter element of the wiper blade in the region of the mount of the wiper arm has side surfaces, which are adapted to the shape of the upper boundary surface and of two lateral boundary surfaces of the wiper arm such that a form-fitting connection is formed, at least in parts, between the side surfaces of the adapter element and the upper boundary surface of the adapter element and the two lateral boundary surfaces of the mount of the wiper arm.

In a further configuration of the invention, the partial region serving as first spoiler element is arranged only on one lateral boundary surface of the mount. However, in an alternative configuration, it may also be provided that the partial region of the mount serving as first spoiler element is arranged on both lateral boundary surfaces of the mount, and that the two lateral boundary surfaces are constructed identically.

A detent connection, which is actuable intuitively for an operator, for releasing the wiper blade from, or mounting same on, the wiper arm is obtained if the second detent element is constructed in the form of an aperture in the upper boundary surface of the mount of the wiper arm. Depending on the structural configuration of the mount, it is possible here for the first detent element to be arranged flush to the wiper lip plane, or else for the first adapter element to be arranged laterally offset to the wiper lip plane, wherein the width of the upper boundary surface is between 25% and 70% of the width of the mount.

Further advantages, features and details of the invention emerge from the description below of preferred exemplary embodiments and with reference to the drawing.

In the drawing:

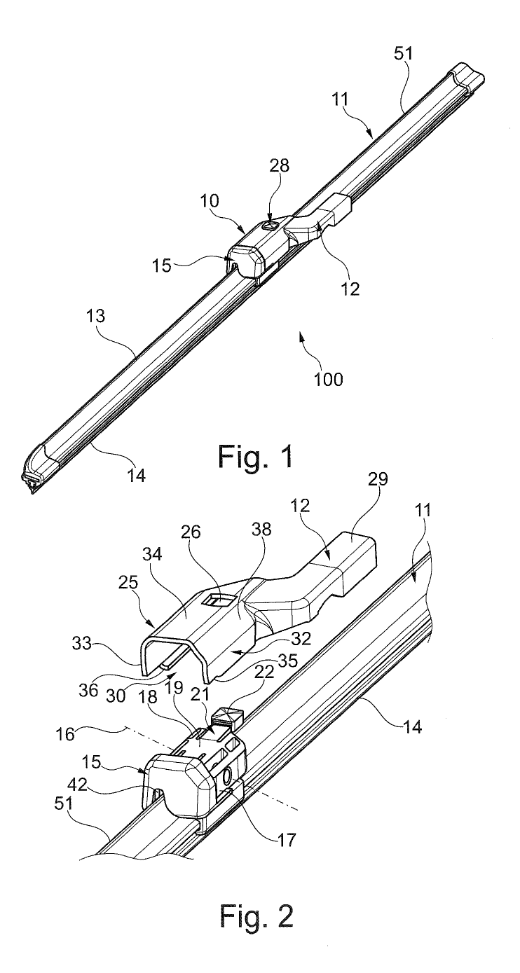

FIG. 1 shows a perspective illustration of a wiper device for cleaning a vehicle window, together with a partial region of a wiper arm and a wiper blade fastened to the wiper arm with the use of a connecting device according to the invention,

FIG. 2 shows a perspective illustration of the components of the wiper device according to FIG. 1 in a state separated from one another,

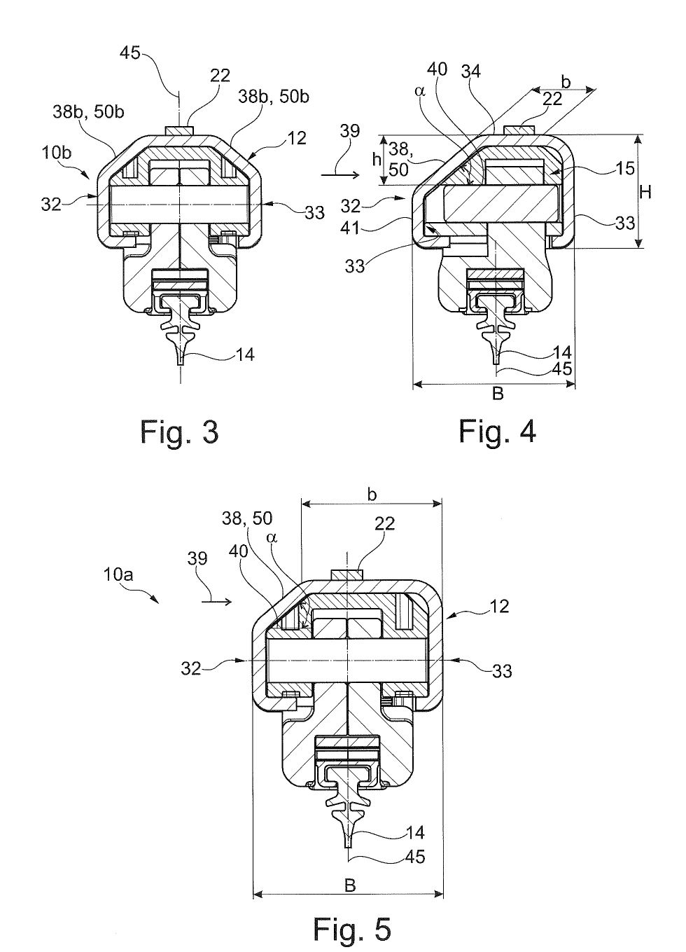

FIG. 3 shows a section, as seen perpendicularly to the longitudinal axis of the wiper blade, through the connecting device between the wiper arm and the wiper blade with a symmetrical configuration of the mount on the wiper arm,

FIG. 4 shows a cross section through the region of the connecting device between the wiper arm and the wiper blade with an asymmetrical construction of the mount on the wiper arm, likewise as seen perpendicularly to the longitudinal axis of the wiper blade,

FIG. 5 shows a cross section through a connecting arrangement modified in comparison to FIG. 4,

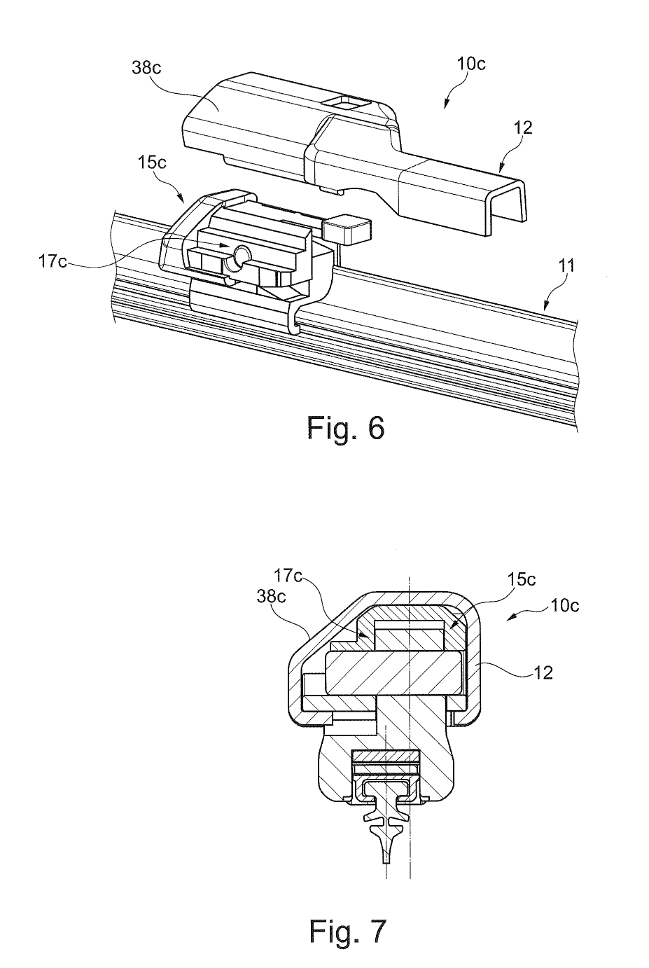

FIG. 6 shows a perspective illustration of a connecting arrangement between the wiper arm and the wiper blade with the use of spoiler-like elements in the region of the wiper blade, and

FIG. 7 shows a cross section, as seen perpendicularly to the longitudinal axis of the wiper blade, through the connecting arrangement according to FIG. 6 in the mounted state.

Identical elements and elements having the same function are provided with the same reference signs in the figures.

FIG. 1 illustrates a wiper device 100 for cleaning a vehicle window, preferably a vehicle windscreen. The wiper device 100 comprises a wiper blade 11 which is fastened exchangeably to a wiper arm 12 via a connecting device 10 according to the invention. According to the illustration in FIG. 1, the wiper blade 11 has an elongated wiper blade body 13 with a wiper lip 14 which is designed to bear against the vehicle window (not illustrated). An adapter element 15 which is at least partially composed of plastic is arranged preferably in the central region of the wiper blade body 13. The adapter element 15 customarily consists of two elements (not illustrated specifically) which are arranged movably with respect to each other about a pivot axis 16 (FIG. 2) in order, during the movement of the wiper blade 11 along the vehicle window, always to permit uniform contact of the wiper lip 14 over the full surface area on the vehicle window.

The adapter element 15, which is of approximately block-shaped design, has side surfaces 17, 18 and an upper side 19 on mutually opposite sides which run parallel to the longitudinal direction of the wiper blade body 13. Furthermore, a first detent element 22 in the form of an actuating button is arranged on the adapter element 15 via a spring tongue 21 on the side facing the wiper arm 12. The first detent element 22 forms a detent connection 28 together with a second detent element 26 which is arranged in a connection region 25 of the wiper arm 12 to the adapter element 15 and is in the form of an aperture.

The connection region 25 of the wiper arm 12 is arranged laterally offset to a connecting section 29, which is connected to the drive of the wiper arm 12 (wiper shaft). The wiper arm 12 is preferably composed of sheet metal and is constructed as a punched/bent part. The connection region 25 has a substantially U-shaped cross section and is constructed to be open on the side facing the adapter element 15 in order to be able to push the adapter element 15 into or pull same out of a mount 30 which is formed by the connection region 25, in order to permit an exchange of the wiper blade 11 in the event of a service. The mount 30 of the connection region 25 is substantially formed by two lateral boundary surfaces 32, 33 and an upper boundary surface 34. The second detent element 26 in the form of the aperture discussed is also arranged in the region of the upper boundary surface 34. The boundary surfaces 32 to 34 of the mount 30 are adapted to the external cross section of the adapter element 15 in such a manner that a form-fitting connection is formed, at least in parts, between the boundary surfaces 32 to 34 of the mount 30 and the side surfaces 17, 18 and the upper side 19 of the adapter element 15. Furthermore, holding sections 35, 36 can be seen on the two boundary surfaces 32, 33, on the side facing away from the upper boundary surface 34, said holding sections 35, 36 also projecting inwards by 90° into the region of the mount 30 and positioning or holding the adapter element 15, and therefore also the wiper blade 11, in a perpendicular direction to the extent of the wiper arm 12 within the mount 30.

According to the illustration in FIGS. 1, 2 and 4, it is provided according to the invention that the boundary surface 32 of the mount 30 of the wiper arm 12 has a partial region 38 which is arranged obliquely by an angle a in relation to the main onflow direction of the airstream, the direction of which is indicated by the arrow 39. The angle a of the partial region 38, which is of flat design, is between 30° and 60°, preferably approximately 45°, in relation to a plane 40 running parallel to the upper boundary surface 34 (FIG. 4). The partial region 38 merges on one side into the upper boundary surface 34 and on the other side into a further partial region 41 which is arranged perpendicularly to the main onflow direction of the airstream (arrow 39), wherein the latter partial region 41 is arranged parallel to the boundary surface 33 of the mount 30. The height h of the partial region 38 in relation to the height H of the mount 30 is between 20% and 80%, preferably approximately 50% of the height H of the mount 30. Furthermore, the width b of the upper boundary surface 34 of the mount 30 or of the connection region 25 is between 25% and 70% of the width B of the connection region 25. Furthermore, FIG. 4 illustrates a wiper lip plane 45 which coincides here with the plane of symmetry of the wiper lip, wherein the two detent elements 22, 26 are arranged laterally offset, i.e. not in alignment or asymmetrically with respect to the wiper lip plane 45. The partial region 38 of the boundary surface 32 forms a first spoiler element 50 which serves to increase the contact pressure of the wiper arm 1 in the direction of the vehicle window, and therefore also the contact pressure of the wiper blade 11, depending on the driving speed of the vehicle.

The wiper blade 11 preferably has a second spoiler element 51 which is arranged in the form of a lip-like elevation on the upper side of the wiper blade body 13, as can be seen in particular with reference to FIGS. 1 and 2. The second spoiler element 51 can be constructed as a continuous, second spoiler element 51 which is formed over the entire length of the wiper blade body 13, for which purpose the adapter element 15 has a corresponding recess 42, or else in the form of two partial elements which are arranged on both sides of the adapter element 15.

The connecting device 10a illustrated in FIG. 5 differs from the connecting device 10 in that the two detent elements 22, 26 are arranged flush or symmetrically to the wiper lip plane 45.

In the case of the connecting arrangement 10b according to FIG. 3, it is provided that the two boundary surfaces 32, 33 have a partial region 38b which is constructed as first spoiler element 50b in a manner corresponding to the partial region 38 of the connecting devices 10, 10a. Furthermore, the two detent elements 22, 26 are also arranged symmetrically to the wiper lip plane 45 or are flush thereto.

Finally, FIGS. 6 and 7 illustrate a connecting device 10c which differs from the connecting device 10 in that the adapter element 15c has, in the partial region 38c, a side surface 17c which is of step-shaped design and, when the wiper blade 11 is mounted, bears in a planar or linear manner only in partial sections in operative connection with the inner side of the partial region 38c (FIG. 7).

The connecting device 10, 10a, 10b, 10c described to this extent can be modified in diverse ways without departing from the inventive concept.

### LIST OF REFERENCE SIGNS

10,10a,10b,10c Connecting device
11 Wiper blade
12 Wiper arm
13 Wiper blade body
14 Wiper lip
15,15c Adapter element
16 Pivot axis
17,17c Side surface
18 Side surface
19 Upper side
21 Spring tongue
22 Detent element
25 Connection region
26 Detent element
28 Detent connection
29 Connecting section
30 Mount
32 Boundary surface
33 Boundary surface
34 Boundary surface
35 Holding section
36 Holding section
38,38b,38c Partial region
39 Arrow
40 Plane
41 Partial region
42 Recess
45 Wiper lip plane
50,50b Spoiler element
51 Spoiler element
100 Wiper device
α Angle
h Height
H Height
b Width
B Width

1. A connecting device between a wiper arm and a wiper blade, wherein:
the wiper blade has an elongated wiper blade body with an adapter element which serves for exchangeable connecting to a connection region of the wiper arm,
the connection region of the wiper arm has a substantially U-shaped mount for the adapter element with an upper boundary surface and two lateral boundary surfaces,
the mount overlaps the adapter element at least in the region of the boundary surfaces, and with a first spoiler element constructed in the connection region of the wiper arm for increasing the aerodynamic contact pressure of the wiper arm onto the wiper blade,
the first spoiler element is constructed as part of a lateral boundary surface of the mount of the wiper arm by a flat partial region of the lateral boundary surface positioned obliquely with respect to an onflow direction of the airstream, and
an angle of the partial region serving as first spoiler element is between 30° and 60° in relation to a plane running parallel to the upper boundary surface.

2. A connecting device between a wiper arm and a wiper blade, wherein:
the wiper blade has an elongated wiper blade body with an adapter element which serves for exchangeable connecting to a connection region of the wiper arm,
the connection region of the wiper arm has a substantially U-shaped mount for the adapter element with an upper boundary surface and two lateral boundary surfaces,
the mount overlaps the adapter element at least in the region of the boundary surfaces, and with a first spoiler element constructed in the connection region of the wiper arm for increasing the aerodynamic contact pressure of the wiper arm onto the wiper blade,
the first spoiler element is constructed as part of a lateral boundary surface of the mount of the wiper arm by a flat partial region of the lateral boundary surface positioned obliquely with respect to an onflow direction of the airstream, and
the obliquely positioned flat partial region of the lateral boundary surface is arranged on the side facing the upper boundary surface, wherein a height of the partial region in relation to a height of the mount is between 20% and 80% of the height of the mount.

3. The connecting device according to claim 2, wherein the angle of the partial region serving as first spoiler element is between 30° and 60° in relation to a plane running parallel to the upper boundary surface.

4. The connecting device according to claim 1, wherein on the adapter element at least a first detent element is constructed, which forms a detent connection together with a second detent element on the wiper arm, and wherein the partial region extends up to the area of the second detent element with respect to a longitudinal direction of the mount.

5. The connecting device according to claim 1, wherein the wiper blade body has on an upper side a second spoiler element, which runs at least substantially over the entire length of the wiper blade body, wherein in the region of the adapter element the second spoiler element is constructed so as to be interrupted or is overlapped by the adapter element.

6. The connecting device according to claim 1, wherein the adapter element of the wiper blade in the region of the mount of the wiper arm has boundary surfaces, which are adapted to the shape of the upper boundary surface and of the two lateral boundary surfaces of the wiper arm such that a form-fitting connection is formed, at least in parts, between the boundary surfaces of the adapter element and the upper boundary surface and the two lateral boundary surfaces of the wiper arm.

7. The connecting device according to claim l, wherein the partial region serving as first spoiler element is arranged only on one lateral boundary surface.

8. The connecting device according to claim 1, wherein the partial region serving as first spoiler element is arranged on both lateral boundary surfaces, and the two lateral boundary surfaces are constructed identically.

9. The connecting device according to claim 4, wherein the second detent element is constructed in the form of an aperture in the upper boundary surface of the mount of the wiper arm.

10. The connecting device according to claim 4, wherein the first detent element is arranged flush to a wiper lip plane.

11. The connecting device according to claim 9, wherein the first detent element is arranged laterally offset to a wiper lip plane.

12. The connecting device according to claim 1, wherein the width of the upper boundary surface is between 25% and 70% of the width of the mount.
